(19) United States
(12) Patent Application Publication
(10) Pub. No.: US 2015/0117640 A1
(43) Pub. Date: Apr. 30, 2015

(54) APPARATUS AND METHOD FOR PERFORMING KEY DERIVATION IN CLOSED DOMAIN

(71) Applicant: Electronics and Telecommunications Research Institute, Daejeon (KR)

(72) Inventors: Jong-Yeon PARK, Daejeon (KR); Young-Ho Kim, Seoul (KR); Yun-Kyung Lee, Daejeon (KR); Jae-Deok Lim, Daejeon (KR); Jeong-Nyeo Kim, Daejeon (KR)

(73) Assignee: Electronics and Telecommunications Research Institute, Daejeon (KR)

(21) Appl. No.: 14/243,093

(22) Filed: Apr. 2, 2014

(30) Foreign Application Priority Data
Oct. 31, 2013 (KR) 10-2013-0131765

(51) Int. Cl. H04L 9/08

(52) U.S. Cl. CPC H04L 9/0869
USPC 380/44

(57) ABSTRACT

Provided are an apparatus and method for guaranteeing the safety of a computing device by separating a closed domain from an open domain in the computing device and allowing the closed domain to perform key derivation that is required for encryption/decryption of data. The computing device includes a hypervisor, the open domain and the closed domain isolated from the open domain without being open to a user, the open domain and the closed domain managed by the hypervisor, and a key derivation executable code configured to generate an encryption key needed to perform encryption in the open domain, from a seed value, the key derivation executable code being executed in the closed domain, wherein the encryption key generated by the key derivation executable code is transferred to the open domain, and is automatically discarded after being used for encryption of data in the open domain.

### CROSS-REFERENCE TO RELATED APPLICATION

This application claims priority to and the benefit of Korean Patent Application No. 10-2013-0131765, filed on Oct. 31, 2013, the disclosure of which is incorporated herein by reference in its entirety.

### BACKGROUND

1. Field of the Invention

The present invention relates to an apparatus and method for performing a key derivation in a closed domain, and more particularly, to an apparatus and method for ensuring the security of a computing device by separating a closed domain from an open domain in the computing device and allowing the separated closed domain to derive a key required for encryption/decryption of data.

2. Discussion of Related Art

An encryption algorithm serves one of the most important functions in encryption of messages, encryption of private information, generation of message authentication codes, and electronic signatures. The most important issue in ensuring security of encryption algorithms is safe storage, generation and management of keys that are used for cryptography. To this end, a key management and generation method using hardware such as a trusted platform module (TPM) and a USIM is widely used, and otherwise, software based key management is used despite its security vulnerability.

The hardware scheme increases the operating cost and is poor in scalability, resulting in limitations on mass production and mass distribution. Meanwhile, the software scheme has a risk of exposing keys to a hacker, and is thus considered inappropriate for guaranteeing security.

### SUMMARY OF THE INVENTION

The present invention is directed to an apparatus and method for performing key derivation, capable of compensating for the inefficiency of a hardware scheme and enhancing the security of a software scheme.

The present invention is directed to an apparatus and method for performing key derivation, capable of ensuring system security by allowing key generation and management for encryption/decryption to be performed on a closed domain separated from an open domain.

According to an aspect of the present invention, there is provided a computing device including: a hypervisor; an open domain and a closed domain isolated from the open domain without being open to a user, the open domain and the closed domain being managed by the hypervisor; and a key derivation executable code configured to generate an encryption key needed to perform encryption in the open domain, from a seed value, the key derivation executable code being executed in the closed domain, wherein the encryption key generated by the key derivation executable code is transferred to the open domain, and is automatically discarded after being used for encryption of data in the open domain.

According to another aspect of the present invention, there is provided a method of performing encryption in a computing device including an open domain and a closed domain, the method including: executing, in the closed domain, a key derivation executable code configured to generate an encryption key needed to perform encryption in the open domain, the key derivation executable code generating the encryption key using a seed value; transferring the encryption key generated by the key derivation executable code to the open domain; encrypting data using the encryption key in the open domain; and discarding the encryption key.

According to still another aspect of the present invention, there is provided a method of performing encryption/decryption communication between a computing device including an open domain and a closed domain and a server, the method including: generating, by the computing device, a first seed value by executing a random number generation executable code provided on the computing device, and generating, by the server, a second seed value by executing a random number generation executable code provided on the server; transferring, by the computing device, the first seed value to the server, and transferring, by the server, the second seed value to the computing device; generating, by the computing device and the server, final seed values using the first seed value and the second seed value, respectively, and executing, by the computing device and the server, key derivation executable codes to generate session keys from the final seed values, the computing device executing the key derivation executable code in the closed domain; and performing the encryption/decryption communication between the open domain of the computing device and the server using the session keys.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic view illustrating a structure of a computing device according to an exemplary embodiment of the present invention.

FIG. 2 is a schematic view illustrating a process of generating an encryption/decryption key in a closed domain and performing encryption/decryption using the generated encryption/decryption key according to a first exemplary embodiment of the present invention.

FIG. 3 is a schematic view illustrating a process of generating an encryption/decryption key in a closed domain and performing encryption/decryption using the generated encryption/decryption key according to a second exemplary embodiment of the present invention.

FIG. 4 is a flowchart showing an encryption process according to an exemplary embodiment of the present invention.

FIG. 5 is a schematic view illustrating encryption/decryption communication between a computing device and a server according to an exemplary embodiment of the present invention.

FIG. 6 is a flowchart showing encryption/decryption communication between a computing device and a server according to an exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Description of techniques which are widely known in the related technical field and not directly related to the present invention are omitted to make essential points of the present invention clear by omitting unnecessary descriptions.

In the present specification and claims, the denoting of “a unit” may be used to refer to one or more units unless specifically mentioned otherwise.

In the present specification, the terms “module,” “unit” and “interface” in general represent computer related objects, and may represent, for example, hardware, software or combinations thereof.

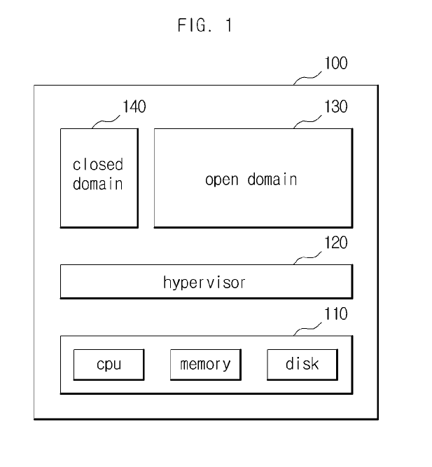

FIG. 1 is a schematic view illustrating a structure of a computing device according to an exemplary embodiment of the present invention. Referring to FIG. 1, a computing device 100 includes a hardware resource 110, such as a central processing unit (CPU), a memory and a disk, a hypervisor 120 located in a higher layer than the hardware resource 110, and an open domain 130 (a public domain) and a closed domain 140 located in a higher layer than the hypervisor 120.

The hypervisor 120 or a virtual machine monitor VMM refers to a logical platform configured to simultaneously support multiple domains (or multiple virtual machines) on a single physical device. Each domain may include a guest operating system (OS) and an application program executable on the corresponding OS. The hypervisor 120 ensures independent execution of each domain through a message transport/notification mechanism between different domains as well as management of a hardware resource, such as allocation/release of a CPU and a memory.

A hypervisor may be classified as a hypervisor type 1 executed directly on hardware or a hypervisor type 2 executed on a host operating system in the same manner as a general program. It is assumed that the present invention is not limited to a particular type of hypervisor, nor influenced by components located in lower layers than the hypervisor.

The open (or public) domain 130 allows access of a user thereto by providing a user interface (for example, Android), while the closed domain 140 is only used for key management and storage and is not open to the user. The present invention is characterized in that even when all values in a public domain are exposed to a hacker, the security is not threatened.

According to an exemplary embodiment of the present invention, encryption/decryption of important data is performed in the open domain 130, and a key required for the encryption/decryption is generated and managed in the closed domain 140.

According to an exemplary embodiment of the present invention, the open domain 130 may include a random number generation executable code configured to generate a seed value that is needed to generate a key for encryption/decryption. The seed value generated in the open domain 130 is transferred to the closed domain 140 and used for generation of an encryption/decryption key. Alternatively, a random number generation executable code may be included in the closed domain 140 such that a seed value is generated in the closed domain 140.

According to an exemplary embodiment of the present invention, the closed domain 140 includes a key derivation executable code configured to generate an encryption key that is needed to perform encryption in the open domain 130. The key derivation executable code may generate the encryption key using the seed value generated by the random number generation executable code and a master key value included in the key derivation executable code. The encryption key generated by the key derivation executable code is transferred to the open domain 130, and is automatically discarded after being used for encryption of important data.

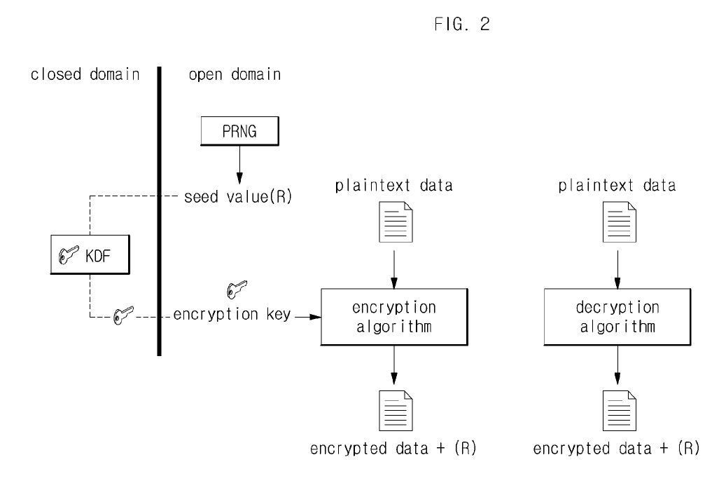

FIG. 2 is a schematic view illustrating a process of generating an encryption/decryption key in a closed domain and performing encryption/decryption using the generated encryption/decryption key according to a first exemplary embodiment of the present invention.

Referring to FIG. 2, a process for generating an encryption key in the closed domain is as follows.

1) The open domain transfers a seed value R generated by a random number generation executable code (pseudo random number generator; PRNG) to the closed domain (the seed value R may be exposed to an attacker).

2) A key derivation function (KDF) execution code is executed using the seed value in the closed domain, thereby generating an encryption key. The key derivation function stores a master key that is not exposed to the outside, and generates the encryption key using the master key and the seed value.

3) The generated encryption key is transferred to the open domain and used for encryption of data. According to an exemplary embodiment of the present invention, an encryption algorithm may include a symmetric-key algorithm, such as Advanced Encryption Standard (AES), Academia, Research Institute and Agency (ARIA), SEED and Data Encryption Standard (DES).

4) The encryption key used for the encryption is automatically discarded after the encryption. Only the encrypted data and the seed value are stored in the open domain. However, even if the seed value and encrypted data stored in the open domain are obtained by an attacker, the attacker is prevented from accessing the closed domain, thereby failing to generate a key required for decryption of the encrypted data.

5) The generation of a decryption key may be achieved in the same manner as the generation of the encryption key, and may be initiated by transferring the seed value R stored in the open domain to the closed domain.

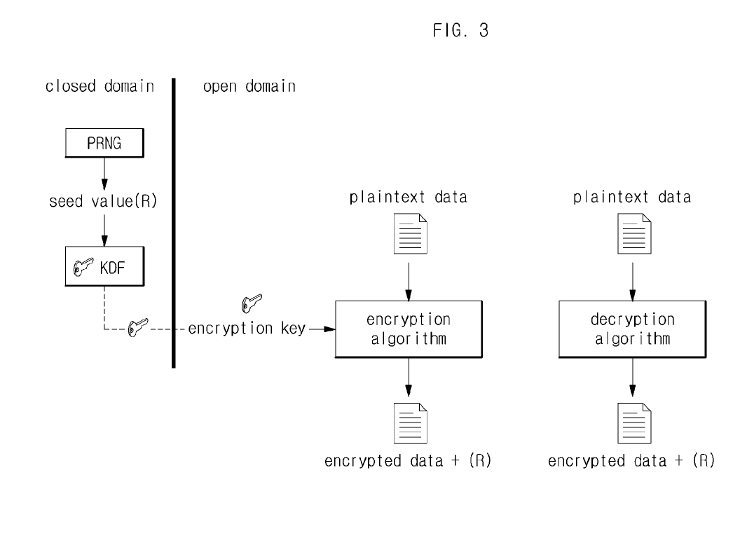

FIG. 3 is a schematic view illustrating a process of generating an encryption/decryption key in a closed domain and performing encryption/decryption using the generated encryption/decryption key according to a second exemplary embodiment of the present invention. A key generating process according to the second exemplary embodiment of the present invention illustrated on FIG. 3 is identical to that of the previous exemplary embodiment as described in FIG. 2, except that the generation of the seed value according to the second exemplary embodiment of the present invention is performed in the closed domain.

Referring to FIG. 3, the key generation process according to the second exemplary embodiment of the present invention is performed as follows.

1) A seed value R is generated by executing a PRNG provided in the closed domain.

2) A KDF executable code provided in the closed domain is executed, thereby generating an encryption key. The key derivation function stores a master key that is not exposed to the public, and generates the encryption key using the master key and the seed value.

3) The generated encryption key is transferred to the open domain and used for encryption of data. According to an exemplary embodiment of the present invention, an encryption algorithm may include a symmetric-key algorithm, such as AES, ARIA, SEED and DES.

4) The encryption key used for the encryption is automatically discarded after the encryption. Only the encrypted data and the seed value are stored in the open domain.

5) The generation of a decryption key may be achieved in the same manner as the generation of the encryption key. Since the seed value R is a value generated in the closed domain, the process of transferring the seed value to the open domain is omitted, unlike the exemplary embodiment of FIG. 2.

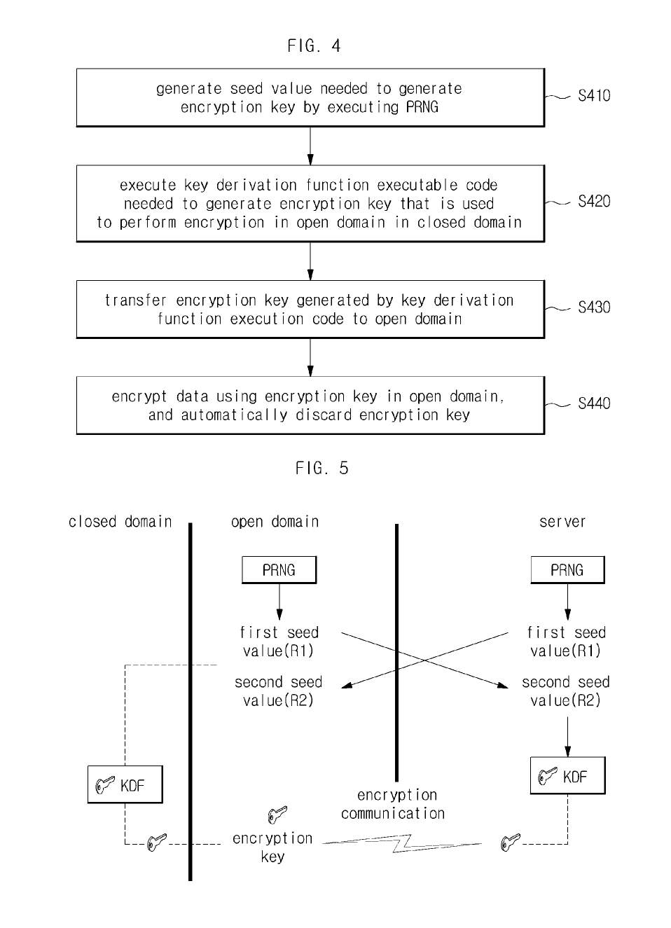

FIG. 4 is a flowchart showing an encryption process according to an exemplary embodiment of the present invention.

A seed value needed to generate an encryption key is generated by executing a random generation executable code (S410). The random number generation executable code may be executed in the open domain or the closed domain, and if the random number generation executable code is executed in the open domain, the generated seed value is transferred to the closed domain.

A key derivation function executable code needed to generate an encryption key that is used to perform encryption in the open domain is executed in the closed domain (S420). The key derivation function stores a master key that is not exposed to the outside, and generates the encryption key using the master key and the seed value.

The encryption key generated by the key derivation function execution code is transferred to the open domain (S430).

Data is encrypted using the encryption key in the open domain, and the encryption key is automatically discarded (440).

Thereafter, a decryption key needs to be generated to decrypt the encrypted data. Similar to the encryption process, the decryption key is generated by executing the key derivation function executable code of the closed domain. If necessary, the seed value stored in the open domain may be transferred to the closed domain to generate the decryption key.

FIG. 5 is a schematic view illustrating encryption/decryption communication between a computing device and a server according to an exemplary embodiment of the present invention. The encryption/decryption communication is performed as follows.

1) As communication objects, a computing device and a server are shown on the left side and the right side of FIG. 5, respectively. It is assumed that the computing device according to an exemplary embodiment of the present invention is provided with an open domain and a closed domain separate from the open domain, and each object shares a master key in advance. A method of sharing a master key in advance according to the present invention is not limited. The shared master key is stored in the closed domain of the computing device, and a method of the server storing the master key according to the present invention is not limited.

2) The server and the computing device generate seed values using respective PRNGs provided on the server and the computing device. The server generates a seed value R1 and the computing device generates a seed value R2. In this case, the server may use a different PRNG from the PRNG used by the computing device. The seed values R1 and R2 are exchanged between the objects to be shared, and even if the seed values R1 and R2 are exposed to an attacker eavesdropping on a network, there is no security issue. As such, the server has the same seed value as the computing device.

3) The computing device transfers a final seed value generated using the seed values R1 and R2 to the closed domain. Alternatively, the closed domain may directly receive the seed values R1 and R2 and generate a final seed value.

4) The server and the closed domain of the computing device generate session keys that are to be used for encryption of data using respective KDF executable codes. The KDF may generate the session key using a master key and a final seed value. The server and the computing device generate session keys using the same KDF executable code, so that both of the objects share the same session key.

5) The computing device and the server perform encryption/decryption communication through a symmetric-key algorithm using the shared session key.

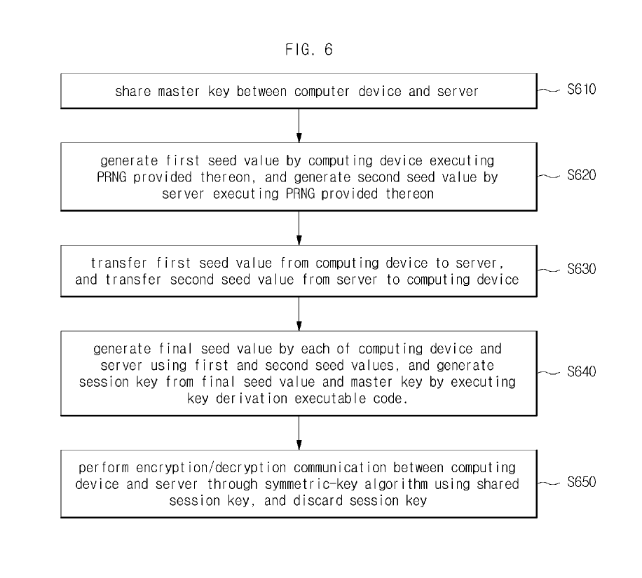

FIG. 6 is a flowchart showing encryption/decryption communication between a computing device and a server according to an exemplary embodiment of the present invention.

The computing device and the server share a master key (S610). In this case, the computing device is assumed to have a closed domain that is separate from an open domain and to which a user is not allowed access. Meanwhile, the method of sharing a master key in advance according to the present invention is not limited. For example, the computing device may store a corresponding master key in the closed domain.

The computing device generates a first seed value by executing a random number generation executable code provided on the computing device, and the server generates a second seed value by executing a random number generation executable code provided on the server (S620).

According to an exemplary embodiment of the present invention, the random number generation executable code provided on the computing device may be identical to or different from the random number generation executable code provided on the server.

The computing device transfers the first seed value to the server, and the server transfers the second seed value to the computing device, so that the both objects have the same seed value (S630).

Each of the computing device and the server generates a final seed value using the first seed value and the second seed value, and generates a session key from the final seed value and a master key by executing a key derivation executable code (S640). In this case, the key derivation executable code executed on the computing device may be identical to the key derivation executable code executed on the server.

According to an exemplary embodiment of the present invention, the computing device performs the generating of the final seed value using the first and second seed values in the open domain, and transfers the generated final seed value to the closed domain. Alternatively, the computing device may transfer the first seed value and the second seed value to the closed domain, and allow the closed domain to generate a final seed value.

Meanwhile, since the computing device according to an exemplary embodiment executes the key derivation executable code in the closed domain, the computing device transfers the session key generated in the closed domain to the open domain.

The computing device and the server perform encryption/decryption communication through a symmetric-key algorithm using the shared session key (S650).

According to an exemplary embodiment of the present invention, a session key is generated whenever data is transferred between the computing device and the server, and automatically discarded after being used for encryption of data to be transferred.

The disclosure can be embodied as program instructions executable through various computing devices and can be recorded in a computer readable medium. The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

As described above, an open domain is separate from a closed domain in an unreliable computing device that is left at risk of public exposure, keys fundamental to encryption/decryption are generated and stored in the closed domain, and even when all values including a seed value stored in the open domain are exposed, data and root keys that are most important to security remain safe.

In addition, according to the present invention, the cost involved in hardware is cut, and the security vulnerability of an open software environment is improved. Further, the present invention can be applied to digital rights management (DRM), safe security network communication, and an encryption file system, and can be used as a security solution ensuring safety and efficiency.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A computing device comprising:
a hypervisor;
an open domain and a closed domain isolated from the open domain without being open to a user, the open domain and the closed domain being managed by the hypervisor; and
a key derivation executable code configured to generate an encryption key needed to perform encryption in the open domain, from a seed value, the key derivation executable code being executed in the closed domain,
wherein the encryption key generated by the key derivation executable code is transferred to the open domain, and is automatically discarded after being used for encryption of data in the open domain.

2. The computing device of claim 1, further comprising a random number generation executable code configured to generate the seed value.

3. The computing device of claim 2, wherein the random number generation executable code is executed in the open domain, and the seed value generated in the open domain is transferred to the closed domain.

4. The computing device of claim 2, wherein the random number generation executable code is executed in the closed domain.

5. The computing device of claim 3, wherein the seed value is stored in the open domain, and transferred to the closed domain to generate a key for decryption when encrypted data is decrypted.

6. A method of performing encryption in a computing device including an open domain and a closed domain isolated from the open domain without being open to a user, the method comprising:
executing, in the closed domain, a key derivation executable code configured to generate an encryption key needed to perform encryption in the open domain, the key derivation executable code generating the encryption key using a seed value;
transferring the encryption key generated by the key derivation executable code to the open domain;
encrypting data using the encryption key in the open domain; and
discarding the encryption key.

7. The method of claim 6, further comprising, in the closed domain, executing a random number generation executable code configured to generate the seed value.

8. The method of claim 6, further comprising, in the open domain, executing a random number generation executable code configured to generate the seed value; and
transferring the generated seed value to the closed domain.

9. The method of claim 8, further comprising storing the seed value in the open domain to generate a decryption key needed to decrypt encrypted data.

10. A method of performing encryption/decryption communication between a computing device including an open domain and a closed domain isolated from the open domain without being open to a user and a server, the method comprising:
generating, by the computing device, a first seed value by executing a random number generation executable code provided on the computing device, and generating, by the server, a second seed value by executing a random number generation executable code provided on the server;
transferring, by the computing device, the first seed value to the server, and transferring, by the server, the second seed value to the computing device;
generating, by the computing device and the server, final seed values using the first seed value and the second seed value, respectively, and executing, by the computing device and the server, key derivation executable codes to generate session keys from the final seed values, the computing device executing the key derivation executable code in the closed domain; and
performing the encryption/decryption communication between the open domain of the computing device and the server using the session keys.

11. The method of claim 10, wherein the computing device performs the generating of the final seed value using the first seed value and the second seed value in the open domain, and transfers the generated final seed value to the closed domain.

12. The method of claim 10, wherein the computing device performs the generating of the final seed value using the first seed value and the second seed value in the closed domain.

13. The method of claim 10, wherein the random number generation executable code provided on the computing device is the same as or different from the random number generation executable code provided on the server.

14. The method of claim 10, wherein the key derivation executable code executed in the closed domain of the computing device is same as the key derivation executable code executed in the server.

15. The method of claim 14, wherein a master key that is needed for the key derivation executable code executed in the closed domain of the computing device to generate the session key and for the key derivation executable code executed in the server to generate the session key is shared in the communication between the computing device and the server.
